(19) United States
(12) Patent Application Publication
(10) Pub. No.: US 2021/0239363 A1
(43) Pub. Date: Aug. 5, 2021

(54) SOLAR APPLIANCE

(71) Applicant: Indian Institute of Technology Bombay, Mumbai (IN)

(72) Inventors: Battula Kalyana Chakravarthy, Mumbai (IN); Avinash Vijay Prabhune, Mumbai (IN)

(21) Appl. No.: 17/051,355

(22) PCT Filed: Apr. 30, 2019
(86) PCT No.: PCT/IN2019/050346

§ 371 Date: Oct. 28, 2020

(30) Foreign Application Priority Data
Apr. 30, 2018 (IN) 201821016241

(51) Int. Cl. F24S 20/30; F24S 80/54; F24S 80/40

(52) U.S. Cl. CPC F24S 20/30; F24S 80/40; F24S 80/54

(57) ABSTRACT

Embodiments herein provide a solar appliance. The solar appliance comprises an outer shell and an inner shell having at least one platform for placing one or more containers. Each of the inner shell and the outer shell are made of a preselected material. The inner shell is configured for receiving the sunlight for heating content inside the one or more containers. The solar appliance further comprises a gap provision provided between the outer shell and the inner shell for allowing a circulation of a medium. The medium insulates the inner shell and conserves the heat inside the inner shell.

### FIELD OF INVENTION

Present disclosure in general relates to solar energy and more particularly to solar appliances. The present application is based on, and claims priority from Indian Application Number 201821016241 filed on 30 Apr. 2018, and PCT/IN2019/050346 filed on 30 Apr. 2019, the disclosure of which is hereby incorporated by reference herein.

### BACKGROUND OF INVENTION

Solar energy is one of a highly utilized energy resource. With an increase in energy demand, solar energy is getting utilized in large number of ways. Solar energy may be used for domestic purposes as well. For example, the solar energy may be used for a purpose of lightning, heating water, and even cooking.

Solar cooking nowadays has become a widely adopted means of cooking. A lot of solar appliances are designed for the purpose of cooking by utilizing sunlight. A typical box type solar cooker works on a black body principle of absorbing all incident radiations and enable cooking inside the cooker. Another type of solar cooker comes in a design of parabolic reflectors for concentrating solar rays at one point. Even combination of parabolic reflection and black body-based cookers are widely known. With all these solar cookers as discussed above, there is one big constraint related to cooker size. These types of solar cooker need large space for deployment. Another constraint in conventional solar cookers is continuous need of tracking sun as the sun moves throughout the day towards west.

These days, due to high-rise buildings and compact apartments, solar cooker with such a large space requirement is not feasible to deploy. Furthermore, direction for placing the solar cooker to receive maximum amount of sunlight may also put a limitation over the use of solar cooker.

### SUMMARY

Accordingly, embodiments herein provide a solar appliance. The solar appliance comprises an outer shell and an inner shell having at least one platform for placing one or more containers. Each of the inner shell and the outer shell are made of a preselected material. The inner shell is configured for receiving the sunlight for heating content inside the one or more containers. The solar appliance further comprises a gap provision provided between the outer shell and the inner shell for allowing a circulation of a medium. The gap provision insulates the inner shell and sustains the heat inside the inner shell.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This method is illustrated in the accompanying drawings, throughout which like reference letters indicate corresponding parts in the various figures. The embodiments herein will be better understood from the following description with reference to the drawings, in which:

FIG. 1 illustrates a front view perspective of the solar appliance, according to the embodiments as disclosed herein;

FIG. 2 illustrates an elaborated cross-sectional side view of the solar appliance of FIG. 1, according to the embodiments as disclosed herein; and

FIG. 3 illustrates a stand-alone set up of the solar appliance of FIG. 1, according to the embodiments as disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

Accordingly, embodiments herein provide a solar appliance. The solar appliance of the present disclosure may be mounted over one of a window, wall, or verticals. The solar appliance may also be kept stand-alone in an open space and may face a south direction for receiving sunlight throughout a day. The solar appliance mounted over the window is easy to access even from inside a building premise.

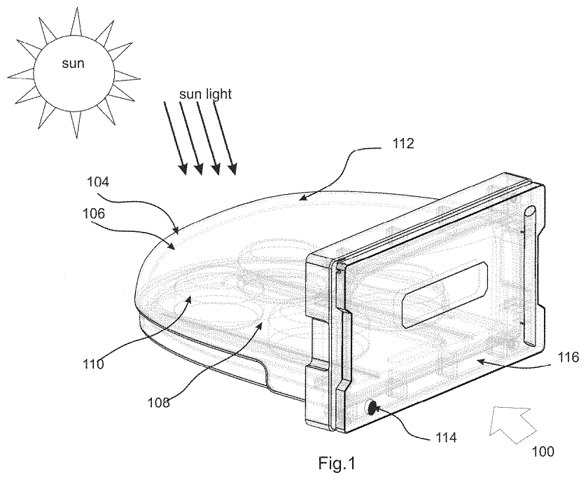

Referring now to the drawings, and more particularly to FIG. 1, there are shown preferred embodiments.

According to an embodiment, referring to FIG. 1, a front view of a solar appliance 100 is shown. The solar appliance 100 comprises having an inner shell 104 and an outer shell 106. The outer shell 104 covers the inner shell 106 and the inner shell 106 comprises at least one platform 108 for placing one or more containers 110. The solar appliance 100 further comprises a gap provision 112 provided between the outer shell 104 and the inner shell 106.

The solar appliance comprises a length in a range of 550 mm to 580 mm, a width in a range of 520 mm to 550 mm and a height in a range of 280 mm to 320 mm.

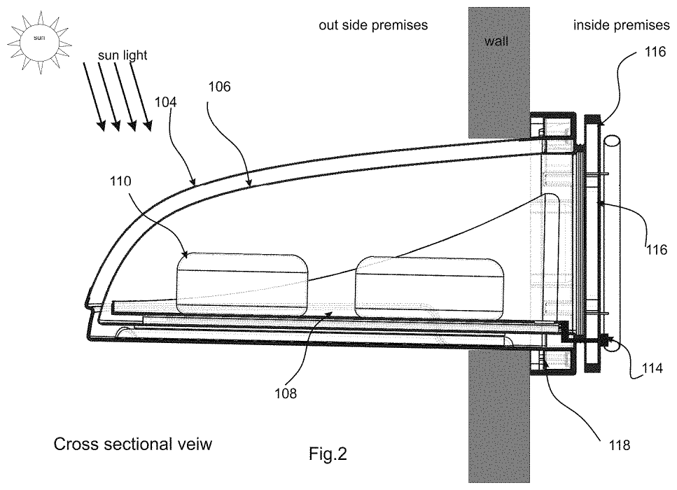

Referring to FIG. 2, a cross-sectional side of the solar appliance 100 is shown. The solar appliance 100 placed in one of an inside premises or outside premises is shown. Each of the outer shell 104 and the inner shell are made of a preselected material. The preselected material of the outer shell 104 comprises a transparent material. The preselected material of the inner shell 106 comprises one of a transparent material, a semi-transparent material, and a non-transparent material. In an example, the transparent material comprises a glass with a thickness.

The one or more containers 110 may be placed on the at least one platform 108 of the inner shell 106. The at least one platform 108 of the inner shell 106 is provided with a radiation absorbing coating so as to absorb a maximum amount of the sunlight.

Contents inside the one or more containers 110 gets heat-up by the sunlight received by the inner shell 106. In an example, the contents may comprise uncooked food items.

For allowing a maximum transfer of heat inside the solar appliance 100 and to conserve the heat, the comprises a gap provision 112 between the outer shell 104 and the inner shell 106. The gap provision 112 allows a circulation of a medium between the outer shell 104 and the inner shell 106. The medium comprises air. The medium may also comprise a non-inflammable non-reactive fluid. The non-inflammable non-reactive fluid is maintained at one of an atmospheric pressure, lower than atmospheric pressure, or higher than the atmospheric pressure.

The medium creates a green-house effect inside the inner shell 106 by making the inner shell 106 a sealed shell and conserving the heat (due to sunlight) inside the inner shell 106. (The greenhouse effect is a natural process that warms the Earth's surface. When the Sun's energy reaches the Earth's atmosphere, some of it is reflected back to space and the rest is absorbed and re-radiated by greenhouse gases. Ref: http://www.environment.gov.au/climate-change/climate-science data/climate-science/greenhouse-effect)

The solar appliance may also comprise a temperature control knob 114 for controlling the temperature inside the inner shell 106 by enabling an exit of the medium from the inner shell 106. The temperature control knob 114 may be rotated to release the medium back to the atmosphere so as to reduce the temperature inside the inner shell 106 of the solar appliance 100. The solar appliance 100 comprises a door 116 for opening and closing of the solar appliance 100.

Still referring to FIG. 2, the solar appliance 100 further comprises a mounting flange 118 for mounting the solar appliance 100 over a predefined place and a mounting bolt 120 for supporting the mounting of the solar appliance 100 over the predefined place. The predefined place comprises one of a window, a wall or verticals.

In an example, for best performance, the solar appliance 100 may be mounted on the window, the wall, or the verticals facing south direction, as south direction receives the sunlight throughout the day.

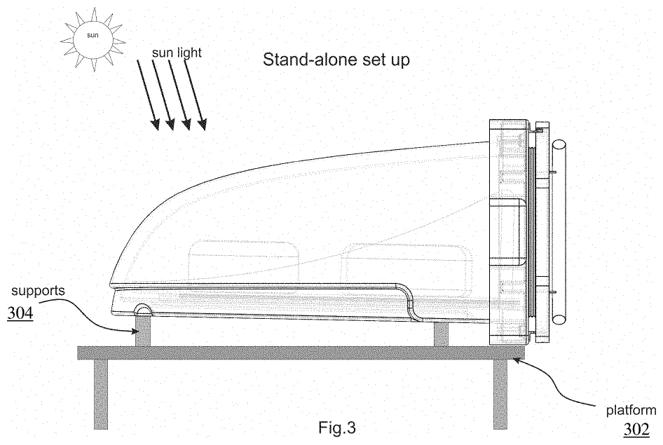

Referring to FIG. 3, a stand-alone set up of the solar appliance 100 is shown. The solar appliance may be placed on a platform 302 with one or more supports 304 provided in the solar appliance 100. The operation of the solar appliance 100 in the stand-alone set up would remain same as discussed above.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A solar appliance, comprising:
an outer shell;
an inner shell having at least one platform for placing one or more containers, wherein each of the inner shell and the outer shell are made of a preselected material, and wherein the inner shell is configured to receive the sunlight for heating content inside the one or more containers; and
a gap provision provided between the outer shell and the inner shell for allowing a circulation of a medium, wherein the medium insulates the inner shell and conserves the heat inside the inner shell.

2. The solar appliance as claimed in claim 1, wherein the solar appliance comprises a length in a range of 550 mm to 580 mm, a width in a range of 520 mm to 550 mm and a height in a range of 280 mm to 320 mm.

3. The solar appliance as claimed in claim 1, wherein the preselected material of the outer shell comprises a transparent material.

4. The solar appliance as claimed in claim 1, wherein the preselected material of the inner shell comprises one of a transparent material, a semi-transparent material, or a non-transparent material.

5. The solar appliance as claimed in claim 1, wherein the at least one platform of the inner shell is provided with a radiation absorbing coating.

6. The solar appliance as claimed in claim 1, wherein the medium comprises an air.

7. The solar appliance as claimed in claim 1, wherein the medium comprises a non-inflammable non-reactive gas maintained at one of an atmospheric pressure, a pressure higher than the atmospheric pressure or a pressure lower than the atmospheric pressure.

8. The solar appliance as claimed in claim 1, comprising:
a door covering an opening of the solar appliance.

9. The solar appliance as claimed in claim 1, comprising:
a mounting flange for mounting the solar appliance over a predefined place; and
a mounting bolt for supporting the mounting of the solar appliance.

10. The solar appliance as claimed in claim 1, wherein the predefined place comprises one of a window, a wall, or a vertical, or a stand-alone place.

11. The solar appliance as claimed in claim 1, comprises:
a temperature control knob for enabling an exit of the medium from the inner shell, wherein the exit of the medium controls the temperature inside the inner shell.
